(19) United States
(12) Patent Application Publication
(10) Pub. No.: US 2009/0021533 A1
(43) Pub. Date: Jan. 22, 2009

(54) Method For Extracting An Inexact Rectangular Region Into An Axis-Aligned Rectangle Image

(76) Inventors: Michael Guerzhoy, North York (CA); Hui Zhou, Toronto (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/779,112

(22) Filed: Jul. 17, 2007

(51) Int. Cl. G09G 5/10

(52) U.S. Cl. 345/672

(57) ABSTRACT

A method and system for extracting an inexact rectangular region into an axis-aligned rectangle image. One example method may include identifying vertices for a rectangular frame within a digital image. A rotation matrix is calculated for rotating the rectangular frame to obtain a rotated rectangular frame. The matrix minimizes the sum total of the squared vertical distances between horizontally aligned vertices and the squared horizontal distances between vertically aligned vertices of the rotated rectangular frame. The method further includes applying the rotation matrix to the rectangular frame to obtain the rotated rectangular frame.

### BACKGROUND

1. The Field of the Invention

The present invention relates to image processing. More specifically, the present invention relates to methods and systems for extracting a rectangular region whose coordinates are not given exactly, and which may not be axis-aligned, from a digital image to generate an exact rectangular image.

2. The Relevant Technology

Computer systems are increasingly used for image processing. For example, computer systems may be configured to examine a photographic digital image and detect the size and location of an object within the image. In many image processing applications, such as digital photography, text and image recognition, and the like, a computing system is required to rotate an image or a region within the image prior to performing further processing.

If the region to be rotated is an exact rectangle whose coordinates are absolutely accurate, the task of rotating the region to be axis-aligned may be quite simple. One of the rectangle's sides may be selected and used to estimate a rotation matrix by finding the angle of the side. After the rotation matrix is calculated, it may be directly applied to the rectangle to rotate the image containing the rectangle around the center of the rectangle. Then, the rotated axis-aligned rectangle may be cropped from the image.

However, in many real image processing applications, an absolutely accurate coordinate value is not always available. Instead, the values may be rounded off to integers for efficiency purposes. Alternatively, the accuracy of the calculation may not be good enough due to limitations of previous processing. For instance, coordinate values of the rectangle may be calculated using a down-sampled, low-resolution image for memory and efficiency purposes. The region for extraction may have inaccurate coordinates since the small round-off error may be amplified due to using the low-resolution image.

The method described above of selecting one of the rectangle's sides and estimating a rotation matrix based on the angle of the side typically assumes the coordinates are absolutely accurate. Because the coordinate values are often inaccurate, this solution for calculating a rotation matrix often produces inaccurate and suboptimal results.

In order to reduce the error caused by inaccurate coordinate values, a second solution uses more than one side and averages the results. For example, the average angle of two approximately parallel sides of a rectangle region may be calculated, and a rotation matrix can be calculated based on the average angle. The image containing the rectangular region may be rotated around the center point of the region, and the rotated axis-aligned rectangle region may be cropped from the image. It is also possible to use more than two sides when calculating the rotation matrix. Although using multiple sides may generate better results than the first method where only one rectangle side is used, this approach often produces unsatisfactory results because the output region often does not yield the best possible exact rectangle.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

The present invention provides methods and systems for extracting a region that has only approximate coordinate information in a given digital image into a substantially exact axis-aligned image. For example, disclosed embodiments pertain to a method of extracting a rectangular region whose coordinates are not known exactly into an axis-aligned rectangular image. The method may include identifying vertices for a rectangular frame within a digital image. A rotation matrix is calculated for rotating the rectangular frame to obtain a rotated rectangular frame. The rotation matrix is such that when it is applied to the vertices of the rectangular frame, the sum total of the squared horizontal distances between vertically aligned vertices and the squared vertical distances between horizontally aligned vertices is minimized The method further includes applying the rotation matrix to the rectangular frame to obtain the rotated rectangular frame.

Another embodiment of the invention relates to a computer-readable medium having computer-executable instructions. The computer-executable instructions include an image database component configured to store an image comprised of at least one rectangular frame including four vertices. The computer-executable instructions further include a matrix generation component configured to calculate a rotation matrix for rotating the rectangular frame to obtain a rotated rectangular frame. The rotation matrix is such that when it is applied to the vertices of the rectangular frame, the sum total of the squared horizontal distances between vertically aligned vertices and the squared vertical distances between horizontally aligned vertices is minimized. The instructions also include a frame rotation component configured to apply the rotation matrix to the rectangular frame to obtain the rotated rectangular frame.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a schematic diagram of one example of a computer system that may be employed for face detection;

FIG. 2 illustrates a schematic diagram of one example of an image processing system;

FIG. 3A illustrates an image having a rectangular region therein, for purposes of illustrating the present invention;

FIG. 3B illustrates a rotated axis-aligned rectangular region, for purposes of the illustrating the present invention;

FIG. 4 illustrates a flow diagram describing one example of a method of extracting an inexact rectangular region into an axis-aligned rectangle image.

### DETAILED DESCRIPTION

In the following detailed description of various embodiments of the invention, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

In the following description, an example embodiment of a method and apparatus for extracting an inexact rectangular region into an axis-aligned rectangle image is provided. The illustrated example defines an error function that is minimized for obtaining a rotation matrix, that when applied to the inexact rectangular region, generates the axis-aligned rectangle. For example, the rotation matrix may be estimated such that a sum total of the squared horizontal distances between vertically aligned vertices and the squared vertical distances between horizontally aligned vertices is minimized.

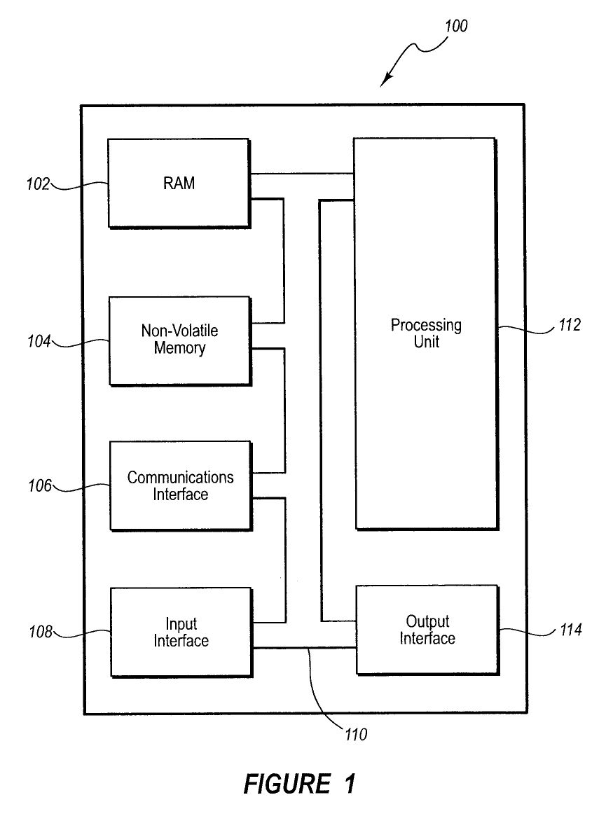

FIG. 1 shows one example of a computer system 100 configured in accordance with an example embodiment. The computer system 100 can be implemented as a personal computer, or similar type of programmable workstation, that can programmably execute image processing software to enable it to process and rotate images, as disclosed in further detail below. As is shown, such a computer system 100 comprises a processing unit 112, random access memory (“RAM”) 102, non-volatile memory 104, a communications interface 106, an input interface 108 and an output interface 114, all in communication over a local bus 110. The processing unit 112 loads and executes software stored in non-volatile memory 104 for image processing. The processing unit 112 may register any ongoing calculations during image processing in RAM 102. The computer system 100 may be coupled to a network or server for storing images and results centrally via the communications interface 106. The input interface 108 may include a keypad and a mouse for interacting with the software for image processing, such as for modifying various settings. The input interface 108 can also include a scanner (or similar image capture device) for capturing images to be processed. The output interface 114 includes a display that can visually present results of the image processing, if so desired, and can display settings of the software to allow for their adjustment.

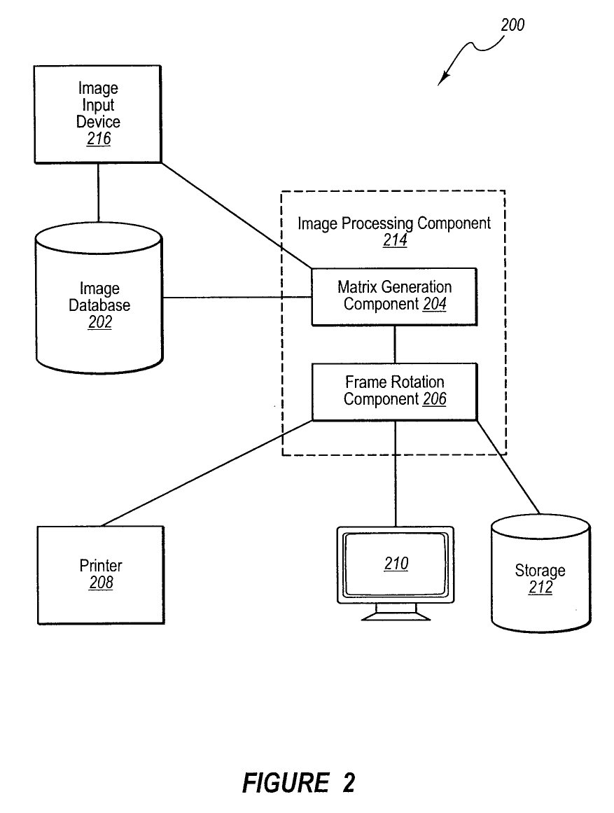

Referring now to FIG. 2, a more detailed example is illustrated using a diagrammed reference to an example embodiment of an image processing system, denoted generally at 200. The example imager processing system 200 includes an image processing component 214, which may receive an image from an image source, such as an image input device 216 or an image database 202. The image processing component 214 performs the necessary image processing steps for generating a rotated axis-aligned rectangular image, as will be described in detail below, and outputs an image to a destination, such as a display 210, a printer 208, or image storage 212.

The image input device 216 may include a scanner, a digital camera, or the like, that may capture an image, temporarily store the image information, and output the stored image information. The image input device 216 is connected to the image processing component 214 to provide the image information to the image processing component 214. The image source may also include an image database 202, which may store the images until the image processing component 214 is ready to receive and process the images. The image input device 216 may be connected to the image database 202 for sending the captured images to the image database 202 for storage prior to being processed by the image processing component 214.

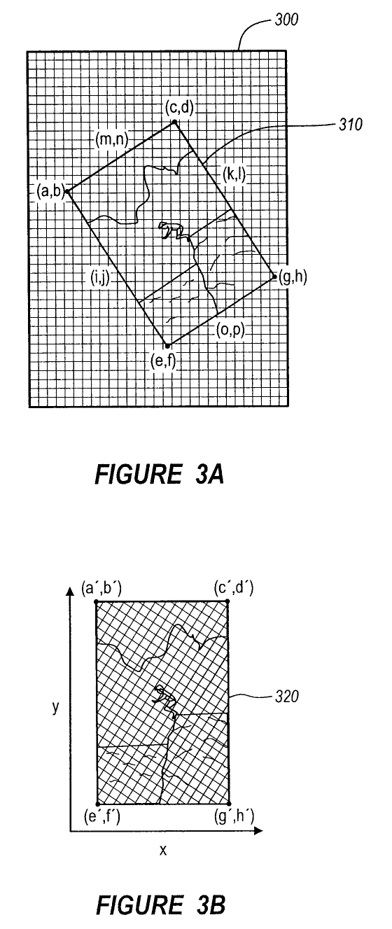

The image processing component 214 may include a matrix generation component 204 and a frame rotation component 206. The image processing component 214 receives a digital image from an input source 216 or 202 that includes a rectangular region. The rectangular region is typically defined by four vertices, the coordinates of the vertices of the frame being {(a, b), (c, d), (e, f), (g, h)}. An example of an image 300 having a rectangular region 310 is provided in FIG. 3A. Coordinates (i, j), (k, l), (o, p), and (m, n) are midpoints of the segments {(a, b), (e, f)}, {(c, d), (g, h)}, {(e, f), (g, h)}, and {(a, b), (c, d)} respectively, in a grid-aligned coordinate system centered at the center of the image 300. The image processing component 214 estimates a rotation matrix for obtaining a rotated rectangular region that is as exact as possible. In other words, the rotated rectangular region is obtained by minimizing an error function, as described in detail below.

The frame rotation component 206 applies the rotation matrix estimated by the image processing component 214 to the image 300 in order to obtain the rotated rectangular region. An example of a rotated rectangular region 320 is provided in FIG. 3B. The rotated rectangular region 320 is output to a destination, such as a printer 208, display 210, or a storage location 212. The extraction result, as generated by the image processing component 214, is as exact as possible, even though the input rectangular region 310 is only an approximate rectangle.

In one embodiment, an optimization model is provided by minimizing an error function to obtain a rotation matrix. The matrix generation component 204 finds the rotation matrix that minimizes the sum of squared vertical distances between the horizontally aligned vertices of the rotated frame 320 and the squared horizontal distances between the vertically aligned vertices of the rotated frame 320. In other words, and referring to FIG. 3B, let the x-axis represent the horizontal direction and the y-axis represent the vertical direction. Therefore, to simplify, the rotation matrix generates a rotated rectangular region wherein the sum total of the squared distance in the y-axis direction between the (a′,b′) and (c′,d′) vertices, the squared distance in the y-axis direction between the (e′,f′) and (g′,h′) vertices, the squared distance in the x-direction between the (a′,b′) and (e′,f′) vertices, and the squared distance in the x-axis direction between the (c′,d′) and (g′,h′) vertices are minimized.

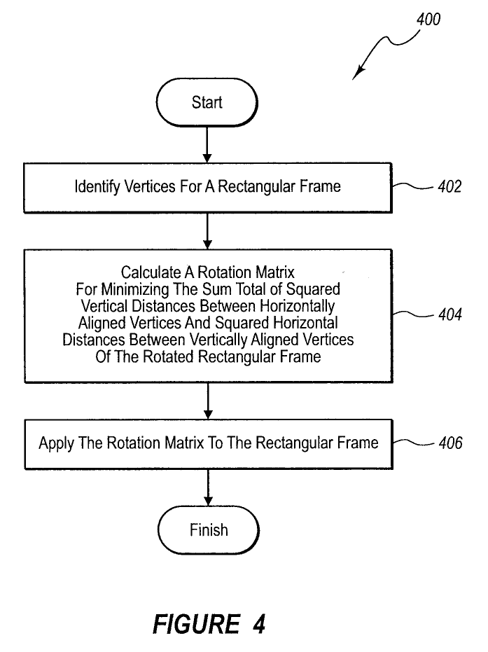

FIG. 4 illustrates one embodiment of an aspect of a method 400 that can be used for extracting an inexact rectangular region into an axis-aligned rectangle image, shown generally from the perspective of an image processor, such as the image processing component 214 in FIG. 2. The method 400, beginning at step 402, identifies vertices for a rectangular frame within a digital image. As described previously, using the rectangular region 310 from FIG. 3A as an example, the identified vertices may include {(a, b), (c, d), (e, f), (g, h)}.

The method 400 further includes, at step 404, calculating a rotation matrix for rotating the rectangular frame to obtain a rotated rectangular frame. As described previously, the rotation matrix is calculated for minimizing the sum total of squared vertical distances between horizontally aligned vertices and squared horizontal distances between vertically-aligned vertices of the rotated rectangular frame.

In one embodiment, the rotation matrix may be expressed using the following equation:

$$M = ( \begin{matrix}x & y \\ - y & x\end{matrix} ) , {x}^{2} + {y}^{2} = 1$$

When the rotation matrix is applied to the rectangular frame, any vertex (a, b) in the input region will become (a′, b′) in the rotated output after. If the result is an exact rectangle, the vertical distance between rotated vertices (a′, b′) and (c′, d′) should be 0 (see FIG. 3B). This desired result may be expressed as:

$$M ( \begin{matrix}a \\ b\end{matrix} ) - M ( \begin{matrix}c \\ d\end{matrix} ) = ( \begin{matrix}t \\ 0\end{matrix} )$$

where t may be any value for representing the horizontal distance between rotated vertices (a′, b′) and (c′, d′). Expanding this expression yields the equation:

(−ya+xb)−(−ye+xd)=0, or

x(b−d)+y(c−a)=0 (1)

Analogously, the vertical distance between the rotated (e, f) and (g, h) vertices should be as close to 0 as possible, i.e.:

x(f−h)+y(g−e)=0 (2)

Similarly, the horizontal distance between the rotated (a, b) and (e, f) vertices should be as close to 0 as possible. This may be expressed with the following equation:

(xa+yb)−(xe+yf)=0 or

x(a−e)+y(b−f)=0 (3)

Analogously, the horizontal distance between the rotated (c, d) and (g, h) vertices should be as close to 0 as possible, i.e.:

x(c−g)+y(d−h)=0 (4)

In other words, in one embodiment, the disclosed methodology determines a rotation matrix M that is optimized such that:

$$\begin{matrix}M ( \begin{matrix}a \\ b\end{matrix} ) - M ( \begin{matrix}c \\ d\end{matrix} ) = ( \begin{matrix}{t}_{1} \\ {u}_{1}\end{matrix} ) \\ M ( \begin{matrix}c \\ d\end{matrix} ) - M ( \begin{matrix}g \\ h\end{matrix} ) = ( \begin{matrix}{t}_{2} \\ {u}_{2}\end{matrix} ) \\ M ( \begin{matrix}a \\ b\end{matrix} ) - M ( \begin{matrix}e \\ f\end{matrix} ) = ( \begin{matrix}{u}_{3} \\ {t}_{3}\end{matrix} ) \\ M ( \begin{matrix}a \\ b\end{matrix} ) - M ( \begin{matrix}e \\ f\end{matrix} ) = ( \begin{matrix}{u}_{4} \\ {t}_{4}\end{matrix} )\end{matrix}$$

where t₁, t₂, t₃, t₄ are any numbers and u₁²+u₂²+u₃²+u₄² is minimized.

The (1), (2), (3), and (4) equations can be expressed together in matrix multiplication form as:

$$A ( \begin{matrix}x \\ y\end{matrix} ) = ( \begin{matrix}0 \\ 0\end{matrix} ) , \\ where \\ A = ( \begin{matrix}b - d & c - a \\ f - h & g - e \\ a - e & b - f \\ c - g & d - h\end{matrix} ) \qquad ( 5 )$$

The above equations provide two parameters (x and y) with four linear equations from (5). In general, where the input rectangle is not exact, this equation has no exact solution other than

$$( \begin{matrix}0 \\ 0\end{matrix} ) .$$

One embodiment of the invention includes minimizing an error function, i.e, calculating a vector

$$( \begin{matrix}x \\ y\end{matrix} )$$

such that

$$‖ A ( \begin{matrix}x \\ y\end{matrix} ) ‖$$

is minimized given that

$$‖ ( \begin{matrix}x \\ y\end{matrix} ) ‖ = 1 ( i . e . , {x}^{2} + {y}^{2} = 1 ) .$$

Calculating the vector

$$( \begin{matrix}x \\ y\end{matrix} )$$

in this manner is analogous to finding the rotation matrix that minimizes the sum of squared horizontal distances between vertically aligned vertices and the squared vertical distances between horizontally aligned vertices.

In one embodiment, the vector

$$( \begin{matrix}x \\ y\end{matrix} )$$

is determined by first computing the least squares solution to equation (5), i.e., by solving the equation:

$${A}^{T} A ( \begin{matrix}x \\ y\end{matrix} ) \approx = 0 given ‖ ( \begin{matrix}x \\ y\end{matrix} ) ‖ = 1 \qquad ( 6 )$$

where:

$${A}^{T} A = ( \begin{matrix}{a}_{1 , 1} & {a}_{1 , 2} \\ {a}_{2 , 1} & {a}_{2 , 2}\end{matrix} )$$

in which

a_{1,1}=(b−d)²+(f−h)²+(a−e)²+(c−g)²

a_{1,2}=(b−d)(c−a)+(f−h)(g−e)+(a−e)(b−f)+(c−g)(d−h)

a_{2,1}=a_{1,2}

a_{2,2}=(c−a)²+(g−e)²+(b−f)²+(d−h)² (7)

In one embodiment, in order to solve the equation (6), the singular vector of A^{T} A is calculated so that its singular value is minimized. Since A^{T} A is a Hermitian matrix (because it is real and symmetric), this is analogous to finding its eigenvector that corresponds to the smaller eigenvalue. The proof and discussion of this result is provided on p. 257 of Gene H. Golub, Charles F. Van Loan, “Matrix Computations”, 3^{rd} Ed., The Johns Hopkins University Press, Baltimore and London, 1996, the contents of which are incorporated herein by reference. Therefore, in one embodiment, the rotation matrix M is determined such that

$$( \begin{matrix}x \\ y\end{matrix} )$$

equals the normalized eigenvector/derived from the smaller eigenvalue of A^{T} A.

The smaller eigenvalue of A^{T} A, denoted at λ, may be calculated as:

$$λ = \frac{( {a}_{1 , 1} + {a}_{2 , 2} ) - \sqrt{{( {a}_{1 , 1} - {a}_{2 , 2} )}^{2} + 4 {a}_{1 , 2} {a}_{2 , 1}}}{2} \qquad ( 8 )$$

The following derivation of λ is provided by way of example:

$$det ( {A}^{T} A - λ I ) = 0$$

$$( {a}_{1 , 1} - λ ) ( {a}_{2 , 2} - λ ) - {a}_{1 , 2} {a}_{2 , 1} = 0$$

$${λ}^{2} - ( {a}_{1 , 1} + {a}_{2 , 2} ) λ + ( {a}_{1 , 1} {a}_{2 , 2} - {a}_{1 , 2} {a}_{2 , 1} ) = 0$$

$$\begin{matrix}{λ}_{1 , 2} = \frac{( {a}_{1 , 1} + {a}_{2 , 2} ) \pm \sqrt{{( {a}_{1 , 1} + {a}_{2 , 2} )}^{2} - 4 ( {a}_{1 , 1} {a}_{2 , 2} - {a}_{1 , 2} {a}_{2 , 1} )}}{2} \\ = \frac{( {a}_{1 , 1} + {a}_{2 , 2} ) \pm \sqrt{{( {a}_{1 , 1} - {a}_{2 , 2} )}^{2} + 4 {a}_{1 , 2} {a}_{2 , 1}}}{2}\end{matrix}$$

By construction, a_{1,1}≧0, a_{2,2}≧0. Therefore, the smaller eigenvalue is

$$λ = \frac{( {a}_{1 , 1} + {a}_{2 , 2} ) - \sqrt{{( {a}_{1 , 1} - {a}_{2 , 2} )}^{2} + 4 {a}_{1 , 2} {a}_{2 , 1}}}{2}$$

The corresponding eigenvector can now be obtained:

$${v}_{λ} = ( \begin{matrix}{a}_{1 , 2} \\ λ - {a}_{1 , 1}\end{matrix} ) , with {a}_{1 , 2} \neq 0$$

The answer for a_{1,2}≠0 is then:

$$( \begin{matrix}x \\ y\end{matrix} ) = \frac{{v}_{λ}}{‖ {v}_{λ} ‖}$$

If a_{1,2}=0, the eigenvector corresponding to the smaller eigenvalue is:

$$( \begin{matrix}x \\ y\end{matrix} ) = \{ \begin{matrix}( \begin{matrix}1 \\ 0\end{matrix} ) , & {a}_{1 , 1} < {a}_{2 , 2} \\ ( \begin{matrix}0 \\ 1\end{matrix} ) , & otherwise\end{matrix} \qquad ( 10 )$$

Therefore, the x, y values from the vector

$$( \begin{matrix}x \\ y\end{matrix} )$$

can be used for the values in the rotation matrix, i.e.:

$$M = ( \begin{matrix}x & y \\ - y & x\end{matrix} ) , {x}^{2} + {y}^{2} = 1.$$

Finally, and referring again to FIG. 4, the rotation matrix M is applied to the rectangular frame to obtain the rotated rectangular frame, as denoted at step 406. For example, rotating the rectangular frame may include rotating the image containing the rectangular frame around an approximate center point of the rectangular frame. The rotated image may be cropped so that only the rotated rectangular frame remains.

In summary, in order to minimize the error function during the extraction of an inexact rectangular region into an axis-aligned rectangle image, one embodiment of the present invention determines a rotation matrix M by calculating the smaller eigenvalue λ, as described in equation (8). Then, the corresponding eigenvector is calculated using equation (9) if a_{1,2}≠0. Otherwise, the corresponding eigenvector is calculated using equation (10). The eigenvector is called

$$( \begin{matrix}x \\ y\end{matrix} ) ,$$

and the rotation matrix

$$M = ( \begin{matrix}x & y \\ - y & x\end{matrix} ) .$$

Referring again to FIGS. 3A and 3B, the image 300 containing the rectangular region 310 may rotated around the center of the rectangular region. The excess portions of the image may be cropped from the rotated axis-aligned rectangle 320. This method of calculating a rotation matrix minimizes the sum total of squared vertical distances between the horizontally aligned vertices of the rotated frame 320 and the squared horizontal distances between the vertically aligned vertices of the rotated frame 320.

Embodiments herein may comprise a special purpose or general-purpose computer including various computer hardware implementations. Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for extracting an inexact rectangular region into an axis-aligned rectangular image, the method comprising:
identifying vertices for a rectangular frame within a digital image;
calculating a rotation matrix for rotating the rectangular frame to obtain a rotated rectangular frame, the rotation matrix calculated for minimizing a sum total of squared vertical distances between horizontally aligned vertices and squared horizontal distances between vertically aligned vertices of the rotated rectangular frame; and
applying the rotation matrix to the rectangular frame to obtain the rotated rectangular frame.

2. The method as recited in claim 1, wherein the rotation matrix is expressed as:
$$M = ( \begin{matrix}x & y \\ - y & x\end{matrix} ) , {x}^{2} + {y}^{2} = 1$$
and wherein the vertices for the rectangle from include {(a, b), (c, d), (e, f), (g, h)}, and wherein the rotation matrix ‘M’ is optimized such that:
$$M ( \begin{matrix}a \\ b\end{matrix} ) - M ( \begin{matrix}c \\ d\end{matrix} ) = ( \begin{matrix}{t}_{1} \\ {u}_{1}\end{matrix} )$$
$$M ( \begin{matrix}c \\ d\end{matrix} ) - M ( \begin{matrix}g \\ h\end{matrix} ) = ( \begin{matrix}{t}_{2} \\ {u}_{2}\end{matrix} )$$
$$M ( \begin{matrix}a \\ b\end{matrix} ) - M ( \begin{matrix}e \\ f\end{matrix} ) = ( \begin{matrix}{u}_{3} \\ {t}_{3}\end{matrix} )$$
$$M ( \begin{matrix}a \\ b\end{matrix} ) - M ( \begin{matrix}e \\ f\end{matrix} ) = ( \begin{matrix}{u}_{4} \\ {t}_{4}\end{matrix} )$$
wherein t₁,t₂,t₃,t₄ are any numbers and wherein u₁²+u₂²+u₃²+u₄² is minimized.

3. The method as recited in claim 1, wherein the rotation matrix is expressed as:
$$M = ( \begin{matrix}x & y \\ - y & x\end{matrix} ) , {x}^{2} + {y}^{2} = 1$$
and wherein the vertices for the rectangle from include {(a, b), (c, d), (e, f), (g, h)}, and wherein the rotation matrix “M” is optimized such that
$$‖ A ( \begin{matrix}x \\ y\end{matrix} ) ‖$$
is minimized, where:
$$A = ( \begin{matrix}b - d & c - a \\ f - h & g - e \\ a - e & b - f \\ c - g & d - h\end{matrix} ) .$$

4. The method as recited in claim 3, wherein the rotation matrix M is further calculated such that
$${A}^{T} A ( \begin{matrix}x \\ y\end{matrix} ) \approx 0.$$

5. The method as recited in claim 3, wherein the rotation matrix M is further calculated such that
$$( \begin{matrix}x \\ y\end{matrix} )$$
equals the normalized eigenvector derived from the smaller eigenvalue of A^{T} A.

6. The method as recited in claim 1, wherein applying the rotation matrix to the rectangular frame to obtain the rotated rectangular frame further comprises rotating the image containing the rectangular frame around an approximate center point of the rectangular frame.

7. A computer-readable medium having computer-executable instructions comprising:
an image database component configured to store an image comprised of at least one rectangular frame including four vertices;
a matrix generation component configured to calculate a rotation matrix for rotating the rectangular frame to obtain a rotated rectangular frame, the rotation matrix calculated for minimizing a sum total of squared horizontal distances between vertically aligned vertices and squared vertical distances between horizontally aligned vertices of the rotated rectangular frame; and
a frame rotation component configured to apply the rotation matrix to the rectangular frame to obtain the rotated rectangular frame.

8. A computer-readable medium as recited in claim 7 having further computer-executable instructions comprising:

9. The computer-readable medium as recited in claim 7, wherein the rotation matrix is expressed as:
$$M = ( \begin{matrix}x & y \\ - y & x\end{matrix} ) , {x}^{2} + {y}^{2} = 1$$
and wherein the vertices for the rectangle from include {(a, b), (c, d), (e, f), (g, h)}, and wherein the rotation matrix ‘M’ is optimized such:
$$M ( \begin{matrix}a \\ b\end{matrix} ) - M ( \begin{matrix}c \\ d\end{matrix} ) = ( \begin{matrix}{t}_{1} \\ {u}_{1}\end{matrix} )$$
$$M ( \begin{matrix}c \\ d\end{matrix} ) - M ( \begin{matrix}g \\ h\end{matrix} ) = ( \begin{matrix}{t}_{2} \\ {u}_{2}\end{matrix} )$$
$$M ( \begin{matrix}a \\ b\end{matrix} ) - M ( \begin{matrix}e \\ f\end{matrix} ) = ( \begin{matrix}{u}_{3} \\ {t}_{3}\end{matrix} )$$
$$M ( \begin{matrix}a \\ b\end{matrix} ) - M ( \begin{matrix}e \\ f\end{matrix} ) = ( \begin{matrix}{u}_{4} \\ {t}_{4}\end{matrix} )$$
wherein t₁,t₂,t₃,t₄ are any numbers and wherein u₁²+u₂²+u₃²+u₄² is minimized.

10. The computer-readable medium as recited in claim 7, wherein the rotation matrix is expressed as:
$$M = ( \begin{matrix}x & y \\ - y & x\end{matrix} ) , {x}^{2} + {y}^{2} = 1$$
and wherein the vertices for the rectangle from include {(a, b), (c, d), (e, f), (g, h)}, and wherein the rotation matrix ‘M’ is optimized such that
$$‖ A ( \begin{matrix}x \\ y\end{matrix} ) ‖$$
is minimized, where:
$$A = ( \begin{matrix}b - d & c - a \\ f - h & g - e \\ a - e & b - f \\ c - g & d - h\end{matrix} ) .$$

11. The computer-readable medium as recited in claim 10, wherein the rotation matrix M is further calculated such that
$${A}^{T} A ( \begin{matrix}x \\ y\end{matrix} ) \approx 0.$$

12. The computer-readable medium as recited in claim 10, wherein the rotation matrix M is further calculated such that
$$( \begin{matrix}x \\ y\end{matrix} )$$
equals the normalizes eigenvector derived from the smaller eigenvalue of A^{T} A.

13. The computer-readable medium as recited in claim 7, wherein the frame rotation component is further configured to rotate the image containing the rectangular frame around an approximate center point of the rectangular frame.

14. In a computer system, a computer program product configured to implement a method of extracting an inexact rectangular region into an axis-aligned rectangle image, the computer program product comprising one or more computer readable media having stored thereon computer executable instructions that, when executed by a processor, cause the computer system to perform the following:
identify vertices for a rectangular frame within a digital image;
calculate a rotation matrix for rotating the rectangular frame to obtain a rotated rectangular frame, the rotation matrix calculated for minimizing a sum total of squared vertical distances between horizontally aligned vertices and squared horizontal distances between vertically aligned vertices of the rotated rectangular frame; and
apply the rotation matrix to the rectangular frame to obtain the rotated rectangular frame.

15. The method as recited in claim 14, wherein the rotation matrix is expressed as:
$$M = ( \begin{matrix}x & y \\ - y & x\end{matrix} ) , {x}^{2} + {y}^{2} = 1$$
and wherein the vertices for the rectangle from include {(a, b), (c, d), (e, f), (g, h)}, and wherein the rotation matrix ‘M’ is optimized such:
$$M ( \begin{matrix}a \\ b\end{matrix} ) - M ( \begin{matrix}c \\ d\end{matrix} ) = ( \begin{matrix}{t}_{1} \\ {u}_{1}\end{matrix} )$$
$$M ( \begin{matrix}c \\ d\end{matrix} ) - M ( \begin{matrix}g \\ h\end{matrix} ) = ( \begin{matrix}{t}_{2} \\ {u}_{2}\end{matrix} )$$
$$M ( \begin{matrix}a \\ b\end{matrix} ) - M ( \begin{matrix}e \\ f\end{matrix} ) = ( \begin{matrix}{u}_{3} \\ {t}_{3}\end{matrix} )$$
$$M ( \begin{matrix}a \\ b\end{matrix} ) - M ( \begin{matrix}e \\ f\end{matrix} ) = ( \begin{matrix}{u}_{4} \\ {t}_{4}\end{matrix} )$$
wherein t₁,t₂,t₃,t₄ are any numbers and wherein the absolute value of u is minimized.

16. The method as recited in claim 14, wherein the rotation matrix is expressed as:
$$M = ( \begin{matrix}x & y \\ - y & x\end{matrix} ) , {x}^{2} + {y}^{2} = 1$$
and wherein the vertices for the rectangle from include {(a, b), (c, d), (e, f), (g, h)}, and wherein the rotation matrix ‘M’ is optimized such that
$$‖ A ( \begin{matrix}x \\ y\end{matrix} ) ‖$$
is minimized, where:
$$A = ( \begin{matrix}b - d & c - a \\ f - h & g - e \\ a - e & b - f \\ c - g & d - h\end{matrix} ) .$$

17. The method as recited in claim 16, wherein the rotation matrix M is further calculated such that
$${A}^{T} A ( \begin{matrix}x \\ y\end{matrix} ) \approx 0.$$

18. The method as recited in claim 16, wherein the rotation matrix M is further calculated such that
$$( \begin{matrix}x \\ y\end{matrix} )$$
equals the normalized eigenvector derived from the smaller eigenvalue of A^{T} A.

19. The method as recited in claim 14, wherein the computer executable instructions that apply the rotation matrix to the rectangular frame to obtain the rotated rectangular frame further comprise instructions, that when executed, rotate the image containing the rectangular frame around an approximate center point of the rectangular frame.
